(19) United States
(12) Patent Application Publication
(10) Pub. No.: US 2015/0328702 A1
(43) Pub. Date: Nov. 19, 2015

(54) DIAMOND WIRE SAW PREVENTING ROTATION OF BEADS

(71) Applicant: Kerong RUAN, Xiamen, Fujian (CN)

(72) Inventor: Kerong RUAN, Xiamen (CN)

(21) Appl. No.: 14/652,788

(22) PCT Filed: Aug. 13, 2013
(86) PCT No.: PCT/CN2013/081362

§ 371 Date: Jun. 16, 2015

(30) Foreign Application Priority Data
Mar. 12, 2013 (CN) 201320111209.6

(51) Int. Cl. B23D 61/18; B28D 1/08

(52) U.S. Cl. CPC B23D 61/185; B28D 1/08

(57) ABSTRACT

A diamond wire saw preventing rotation of beads. A plurality of diamond beads are strung on a steel wire rope, the beads are combined with and fixed to the steel wire rope by injecting a rubber and plastic material, two sides of a substrate pipe of the diamond beads are pressed into a polygonal pipe mouth structure and the pipe mouth is wrapped by the rubber and plastic material, so that the diamond beads cannot rotate easily. In addition, concave lines or convex lines are disposed on inner walls of the diamond beads in the direction of the steel wire rope. The concave lines or the convex lines are embedded into the rubber and plastic material by injecting, the rubber and plastic material, and the holding force and the friction force of the diamond beads are improved.

### FIELD OF THE INVENTION

The invention is related to a diamond wire saw preventing rotation of beads. According to the International Patent Classification (IPC), the invention is belong to the field of the diamond wire saw, specifically related to a diamond wire saw which prevents rotation of beads in cutting process.

### BACKGROUND

The diameters of the existing diamond wire saws are all above 7.2 mm. They mainly include several diamond beads, a steel wire rope, a rubber and a plastic spacer layer. The diamond beads are strung into the steel wire rope, and injected with a plastic layer injection molding machine or hot-pressed to form a rubber layer in a vulcanizing machine. Then a rubber or plastic spacer layer is formed, and a diamond wire saw is manufactured. Therein, diamond beads are composed by a cylinder substrate and a cylinder working layer sintered on the cylinder substrate. However, the minimum of the external diameter of the traditional diamond wire saw is about 7 mm, the maximum of which is about 11 mm. The external diameter of the inner core steel wire rope is about 4 mm. Therefore, there are below several defects in the cutting process: firstly the manufacture material costs much, including the cost of the high quality steel wire rope and the diamond working layer. Secondly, large size and high power cutting machine is needed because of the large diameter, which increases the cost of the device. Thirdly, the width of the kerf is big because of the large diameter of the diamond wire saw. For example, a diamond wire saw with a diameter of 7.2 mm would form a kerf of 8 mm. The reasons stated above limit the wide application of the diamond wire saw, and the cutting of the granite rough block still uses traditional carborundum saw. Therefore, designing a new diamond wire saw with small diameter and low cost is very urgent needed in the field. For example, a diamond wire saw with a diameter below 6 mm can he made. The small diameter of the diamond beads requires a small diameter of the steel wire rope, a thin substrate of beads or without substrate, so as to ensure the thickness of working layer and extend the service life to meet requirement of the cost performance.

### SUMMARY OF THE INVENTION

Because of the defects of existing technology, the invention provides a diamond wire saw preventing rotation of beads, through pressing two sides of the substrate pipe into a square or polygon shape, combining with rubber plastic material and being fixed to the steel wire rope.

To achieve the above purpose, the invention is carried out by the technical proposal below:

In a diamond wire saw preventing the rotation of beads, a plurality of diamond beads are strung on a steel wire rope. The beads are combined with and also fixed to the steel wire rope by injecting a rubber and plastic material. The two sides of a substrate pipe of the diamond beads are pressed into a polygonal pipe mouth structure, and the pipe mouth is wrapped by a rubber and plastic material. The rubber and plastic material is injected between the wire rope and the diamond beads to form a spacer layer.

Further, the shape of the two sides of the substrate pipe are square, pentagon, or hexagon.

Further, two side s of the substrate are pressed into polygon shapes on the steel wire rope directly.

Further, the diamond beads are made by sintering the substrate pipe and diamond working, layer. The inner wall of the substrate pipe is set with a plurality of concave lines or convex lines in the direction of steel wire rope. The concave lines or the convex lines are embedded into the rubber and plastic material by injecting the rubber and plastic material, which improves the holding force and the friction force of the diamond beads.

In the invention, two sides of the diamond beads are pressed into an approximate square or a polygon shape. After injecting the rubber and plastic material, the rubber and plastic material wraps the polygon, so that the diamond beads cannot rotate easily.

### BRIEF DESCRIPTION OF THE DRAWINGS

FIG. 1 is a schematic diagram of diamond beads of the invention.

FIG. 2 is a section view of A-A in FIG. 1.

FIG. 3 is a section view of B-B in FIG. 1.

FIG. 4 is a schematic diagram of the concave lines of the invention.

FIG. 5 is a schematic diagram of the convex lines of the invention.

FIG. 6 is a section view of diamond wire saw of the invention.

### DETAIL DESCRIPTION OF THE INVENTION

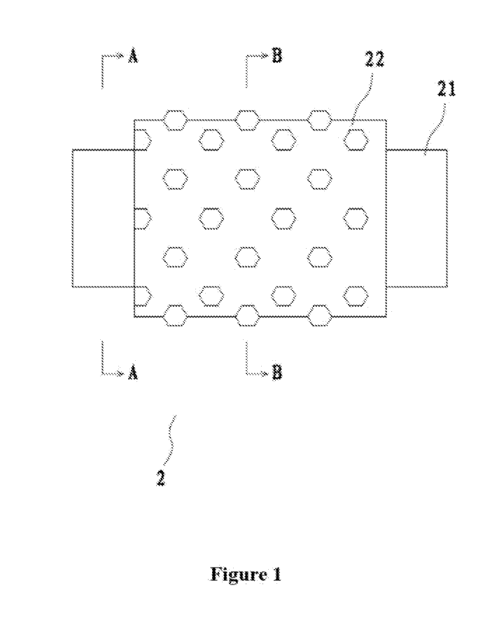

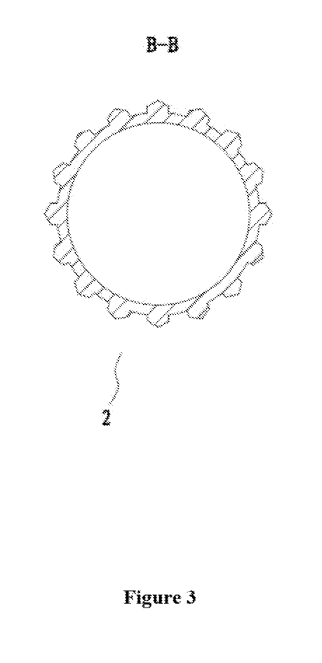

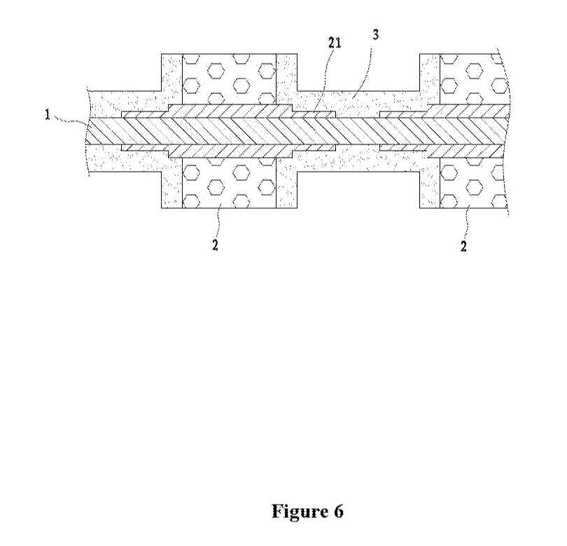

FIGS. 1 to 6, show a diamond Wire saw preventing rotation of beads. A plurality of diamond beads 2 are strung on a steel wire rope 1. The beads are combined With and fixed to the steel wire rope by injecting a rubber and plastic material. Two sides of a substrate pipe 21 of the diamond beads are pressed into a polygonal pipe mouth structure 210, and the pipe mouth is wrapped by a rubber and a plastic material. The rubber and plastic material is injected between steel wire rope 1 and diamond beads 2 to form a spacer layer 3. Diamond beads 2 are made by sintering substrate pipe 21 and diamond working layer 22. The inner wall of substrate pipe 21 is set with concave lines 200 or convex lines 201 in the direction of steel wire rope 1. The concave lines or the convex lines are embedded into the rubber and plastic material by injecting the rubber and plastic material, which improves the holding force and the friction force of the diamond heads.

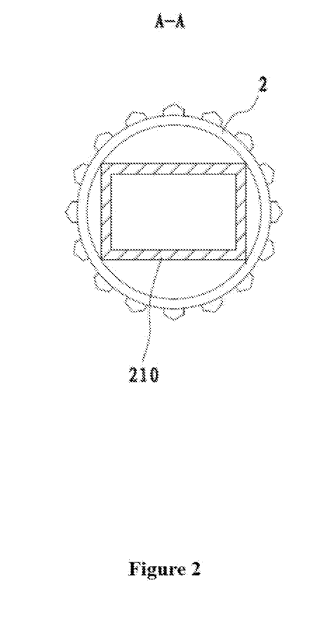

Two sides of substrate pipe 21 are designed into an approximate square shape. Two sides of the substrate pipe 21 are pressed into an approximate square or a polygonal pipe shape after sintering (FIG. 1 or 2), then substrate pipe 21 extended from two sides of diamond beads 2 transform from a circle into a polygon. After injecting the rubber and plastic material, the rubber and plastic material wraps the polygon, so that diamond beads 2 cannot rotate easily. Two sides of substrate pipe 21 can also be formed into a polygon shape before sintering, then substrate pipe 21 is sintered after being, covered with the diamond layer. Also, diamond beads with circler substrate pipe can be strung on steel wire rope 1 directly, and the two sides of the circler substrate pipe are pressed into a polygon shape on steel wire rope 1 and injected with the rubber and plastic material. In the pressing process, a mode limiting the size is needed to avoid damaging the steel wire rope.

The steps to carry out the invention are described below:

Mix diamond 100 of particle size 40/50 with metal power evenly. The components are below: 53% copper power, 30% steel power, 10% nickel power, 5% tin power and 2% diamond. Thereafter, put the mixture into a steel mode to mold by cold press after the mixture is mixed completely. A diamond bead green-body is formed with external diameter of 4.8 mm, inner diameter of 2.2 mm, and length of 6 mm. Then string a steel pipe with external diameter of 2.2 mm, length of 12 mm, and wall thickness of 0.15 mm into the inner hole of the green body. Thereafter, put the diamond bead green body with steel pipe into a high temperature stove for sinter molding, then diamond bead 2 with a steel pipe is generated. Thereafter, put the diamond bead into a steel mold to press the steel pipe extending from the two sides of the diamond bead into an approximate square or a polygon shape (FIG. 2). Then string the diamond bead two sides of which are approximate square or polygon shape on a steel wire rope with diameter of 1.5 mm, and form a whole diamond wire saw after injecting the rubber and plastic material. Another method to manufacture the wire saw is described below. String the sintered diamond beads with steel pipe on a steel wire rope directly, and put each of the diamond beads into a steel mold of which the shape is designed. Thereafter, press the steel pipe extending from the two sides of the diamond bead on the steel wire rope directly. Preferably, the pressure is in four directions, namely, the shape is formed into a square, an approximate square, a hexagon or other geometric morphologies. The purpose is to transform the steel pipe in the pressing process and make the steel pipe fixed to the steel wire rope, on the other hand, the steel pipe is transformed from circle shape into square shape and combined with rubber and plastic material. The diamond wire saw will not easily rotate in the cutting process because the two ends of the steel pipe are squares.

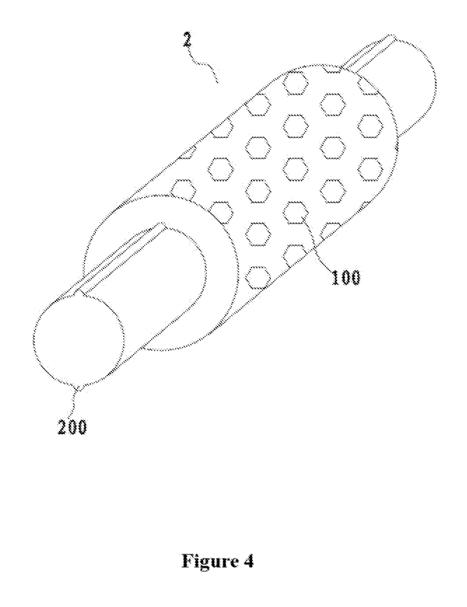

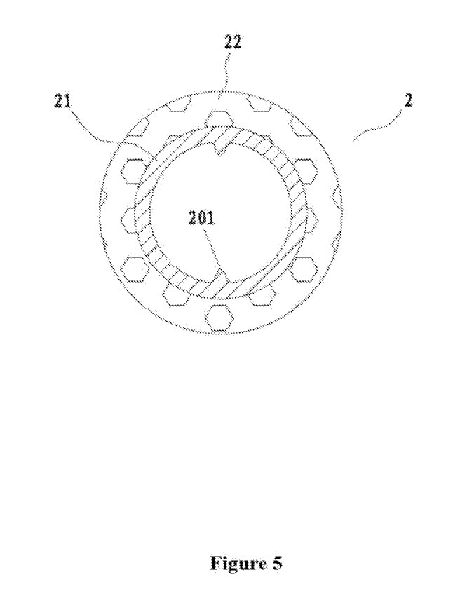

Same as the green body process by cold pressing stated above, the cold pressing mode is changed, namely, convex lines are set in two sides of the core of the cold pressing mode, which forms two concave lines on the inner wall of the diamond beads with width of 0.3 mm and depth of 0.3 mm. This kind of diamond beads can be strung on a diamond wire saw without containing the substrate layer. Thereafter, inject and embed the rubber and plastic material into the concave lines on the inner wall of the diamond wire saw to form a union. In the cutting process, diamond beads will not easily rotate because of the bonding effects of the concave lines. Similarly, the inner wall of the diamond side can be changed into a shape with convex lines, which can also prevent the rotation of diamond beads in the cutting process. The shape stated above is a kind of diamond beads without steel substrate pipe 21. Another shape which is similar to the stated shape is with a substrate pipe 21, namely, the inner wall of the steel substrate pipe 21 is set with a plurality of convex lines or concave lines (FIG. 4 or 5). Thereafter, press the steel substrate pipe into the diamond working layer green body and form a diamond wire saw with the same effect after sintering.

The description stated above are embodiments of the invention. It is to be understood that the various equivalent modifications and the variations of the embodiments made by a person who has an ordinary skill in the art are all within the scope of the present invention, and the invention is not limited to these embodiments.

1. A diamond wire saw preventing rotation of beads, comprising:
a plurality of diamond beads strung on a steel wire rope;
wherein the diamond beads are combined with awl fixed to the steel wire rope by injecting a rubber and plastic material;
wherein two sides of a substrate pipe of the diamond heads are pressed into a polygonal pipe mouth structure, and the substrate pipe mouth is wrapped by a rubber and plastic material;
wherein the rubber and plastic material is injected between the steel wire rope and the diamond beads to form a spacer layer.

2. The diamond wire saw preventing rotation of beads of claim 1, wherein the shape of two sides of the substrate pipe are square, pentagon, or hexagon.

3. The diamond wire saw preventing rotation of beads of claim 1, wherein two sides of the substrate pipe are pressed into polygon shapes on the steel wire rope directly.

4. The diamond wire saw preventing rotation of beads of claim 1, wherein the diamond beads are made by sintering the substrate pipe and a diamond working layer;
wherein the inner wall of the substrate pipe is set with a plurality of concave lines or convex lines in the direction of the steel wire rope;
wherein the concave lines or the convex lines are embedded into the rubber and plastic material by injecting the rubber and plastic material which improves the holding force and the friction force of the diamond beads.

5. The diamond wire saw preventing rotation of beads of claim 2, wherein the diamond beads are made by sintering the substrate pipe and a diamond working layer;
wherein the inner wall of the substrate pipe is set with a plurality of concave lines or convex lines in the direction of the steel wire rope;
wherein the concave lines or the convex lines are embedded into the rubber and plastic material by injecting the rubber and plastic material which improves the holding force and the friction force of the diamond beads.

6. The diamond wire saw preventing rotation of beads of claim 3, wherein the diamond beads are made by sintering the substrate pipe and a diamond working layer;
wherein the inner wall of the substrate pipe is set with a plurality of concave lines or convex lines in the direction of the steel wire rope;
wherein the concave lines or the convex lines are embedded into the rubber and plastic material by injecting the rubber and plastic material which improves the holding force and the friction force of the diamond beads.
